(19) United States
(12) Patent Application Publication
(10) Pub. No.: US 2026/0296101 A1
(43) Pub. Date: Oct. 1, 2026

(54) WHEEL HUB MONITORING SYSTEM

(71) Applicant: Dezine Group LLC, Dewitt, MI (US)

(72) Inventor: Aaron Lundy, Dewitt, MI (US)

(21) Appl. No.: 19/564,082

(22) Filed: Mar. 11, 2026

Related U.S. Application Data
(60) Provisional application No. 63/770,085, filed on Mar. 11, 2025.

(51) Int. Cl. B60B 27/00; B60B 7/00

(52) U.S. Cl. CPC B60B 27/0068; B60B 7/0013; B60B 2900/3316

(57) ABSTRACT

A monitoring system is configured to monitor one or more wheel hubs of a trailer or vehicle. The monitoring system includes a sensor unit and a controller. The sensor unit includes one or more temperature sensors and is configured to couple to a wheel hub. At least one of the temperature sensors is configured to sense a temperature output by the wheel hub. The receives temperature data from the one or more temperature sensors and analyzes the temperature data by determining whether the temperature data satisfies a temperature criterion. The controller is configured to provide an alert if the temperature data satisfies the temperature criterion.

### CROSS-REFERENCE TO RELATED APPLICATIONS

This application claims priority to and the benefit of U.S. Provisional Patent Application No. 63/770,085, filed Mar. 11, 2025, and titled Wireless Trailer Monitoring System, the entire disclosure of which is incorporated by reference herein.

### TECHNICAL FIELD

The present disclosure relates generally to a monitoring system and, more specifically, to a wireless monitoring system for wheel hubs of trailers.

### BACKGROUND

Operators of towable vehicles may detect wheel issues of the trailer, such as brake and bearing failure, through excessive heat, vibrations, or other components on components during and after operation. However, because these issues are associated with the trailer and not in the vehicle itself, the operator of the vehicle may be less likely to detect those issues or indicators associate with the trailer. It would be advantageous to provide a wireless monitoring system that detects and communicates potential wheel issues while the towable vehicle is in operation.

### BRIEF SUMMARY

Disclosed herein are implementations of an advanced wireless monitoring system and wheel assemblies including the same.

In an implementation, a wireless monitoring system includes a sensor unit, a receiving device, and a wireless communication module. The sensor may be provided with a temperature sensor and a motion sensor and may be configured to engage a wheel hub. The receiving device may be configured to receive data from the sensor unit. The wireless communication module may be electronically connected to the sensor unit and configured to transmit data from the sensor unit to the receiving device.

In an implementation, a method of monitoring the condition of a wheel hub of a trailer using a wireless monitoring system may include mounting a sensor unit to at least one wheel hub, sensing temperature and vibration patterns of the at least one wheel hub via the sensor unit, wirelessly transmitting the temperature and vibration patterns to a receiving device, and analyzing the temperature and vibration patterns to identify data exceeding criterion.

In an implementation, a non-transitory computer-readable medium tangibly embodying computer-executable operation of a program being executable by a hardware processor may include operations including sensing a temperature and a vibration pattern of at least one wheel hub of a trailer via a sensor unit engaged with wheel hub, transmitting the temperature and vibration patterns to a receiving device, comparing the temperature and vibration patterns of the at least one wheel hub, and providing a feedback to a user in real-time based on the comparison of the temperature and vibration patterns.

In an implementation, a system for monitoring wheel hubs of a trailer may include a sensor unit, a wireless communication modules, and a receiving device. The sensor unit may be configured to mount to each wheel hub of a trailer and collect temperature data and vibration pattern data of each wheel hubs. The wireless communication unit may be configured to transfer the temperature data and vibration pattern data of each of the wheel hubs. The receiving device may be configured to receive and compare the temperature data and vibration pattern data of each of the wheel hubs to identify data exceeding criterion and provide a notification to an operator.

In an implementation, a monitoring system is configured to monitor one or more wheel hubs of a trailer or vehicle. The monitoring system includes a sensor unit and a controller. The sensor unit includes one or more temperature sensors and is configured to couple to a wheel hub. At least one of the temperature sensors is configured to sense a temperature output by the wheel hub. The receives temperature data from the one or more temperature sensors and analyzes the temperature data by determining whether the temperature data satisfies a temperature criterion. The controller is configured to provide an alert if the temperature data satisfies the temperature criterion.

The temperature criterion may be one of a threshold temperature criterion or a differential temperature criterion. The sensor unit may further include one or more motion sensors, and the controller may receive motion data from the one or more motion sensors and may analyze the motion data by determining whether the motion data satisfies a motion criterion. The motion criterion may be one of a vibration criterion or a rotation criterion. The controller may be configured to provide another alert if the motion data satisfies the motion criterion. The sensor unit may include an enclosure and the controller, and the enclosure may contain the controller and the motion sensor. The sensor unit may be configured to couple to the wheel hub by the enclosure coupling to a dust cap of the wheel hub.

In an implementation, a monitoring system is configured to monitor multiple wheel hubs of a trailer or vehicle. The monitoring system includes a first sensor unit, a second sensor unit, and a receiving device. The first sensor unit is configured to couple to a first wheel hub of a trailer. The first sensor unit includes a first sensor that senses a first characteristic of the first wheel hub and a first controller that receives first data from the first sensor. The first characteristic is one of temperature or motion. The second sensor unit is configured to couple to a second wheel hub of the trailer. The second sensor unit includes a second sensor that senses a second characteristic of the second wheel hub and a second controller that receives second data from the second sensor. The second characteristic is the first characteristic. The receiving device includes a third controller that receives the first data from the first controller of the first sensor unit and the second data from the second controller of the second unit. The third controller analyzes the first data and the second data by determining whether a difference between the first data and the second data satisfies a differential criterion. The receiving device provides an alert if the differential criterion is satisfied.

The first characteristic and the second characteristic may be motion. The differential criterion may be a rotational velocity criterion. The third controller may determine whether a difference between a first rotational velocity of the first data and a second rotational velocity of the second data exceeds the rotational velocity criterion. The first first controller may analyze the first data by determining whether the first data satisfies another criterion irrespective of the second data. The first controller may provide a first alert if the first data satisfies the other criterion. The second controller may analyze the second data by determining whether the second data satisfies the other criterion irrespective of the first data. The second controller may provide a second alert if the second data satisfies the other criterion.

The first sensor unit may include a third sensor that senses temperature of the first wheel hub, and the second sensor unit may include a fourth sensor that senses temperature of the second wheel hub. The first controller may analyze the third data by determining whether the third data satisfies a temperature criterion irrespective of the fourth data and may output a third alert if the third data satisfies the temperature criterion. The second controller may analyze the fourth data by determining whether the fourth data satisfies the temperature criterion irrespective of the third data, and may output a fourth alert if the fourth data satisfies the temperature criterion.

In an implementation, a monitoring system is configured to monitor one or more wheel hubs of a trailer or vehicle. The monitoring system includes a sensor unit having an enclosure that contains or is coupled to a sensor and contains a power source, a controller, and a wireless communication module. The enclosure may be configured to couple to a dust cap of a wheel hub. The sensor is configured to detect a characteristic of the wheel hub. The controller receives data from the sensor and is configured to at least one of analyze the data or wirelessly transmit the data with the communication module.

The monitoring system may include a seal that is configured to couple to an opening of the dust cap of the wheel hub. The enclosure may be configured to couple to the seal to close the opening of the dust cap and couple the sensor unit to the wheel hub. The sensor may be a temperature sensor that is positioned to sense temperature of the wheel hub inside the other dust cap. The monitoring system may further include another sensor unit, another seal, and a receiving device. The other sensor unit may include another enclosure that contains or is coupled to another sensor and may contain another power source, another controller, and another wireless communication module. The other enclosure may be configured to couple to another dust cap of another wheel hub. The other sensor may be a temperature sensor that is positioned to sense temperature of the other wheel hub from inside the other dust cap. The controller may receive other data from the other sensor and may be configured to at least one of analyze the other data or wirelessly transmit the other data with the other communication module to the receiving device. The controller may be configured to transmit the data with the communication module to the receiving device.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity. Like reference numerals indicate like parts throughout the drawings.

FIG. 1 illustrates a schematic view of the exemplary monitoring system.

FIG. 2A illustrates a conventional wheel hub and dust cap.

FIG. 2B illustrates a sensor unit of the monitoring system of FIG. 1 attached to the wheel hub of FIG. 2A via a dust cap.

FIG. 3 illustrates a side view of the sensor unit of FIG. 2A.

FIG. 4 illustrates a view of the sensor unit of FIG. 2A.

FIG. 5 illustrates cross-sectional view of the sensor unit of FIG. 2A.

FIG. 6 illustrates an exploded view of the sensor unit separated from the dust cap.

FIG. 7 illustrates an exploded view of the sensor unit separated from a dust seal cap and the dust cap.

FIG. 8 illustrates an exploded view of the sensor unit itself separated from the dust seal cap and the dust cap.

FIG. 9 illustrates an exploded view of the sensor unit itself separated from the dust seal cap and the dust cap.

FIG. 10 is a perspective view another embodiment of the sensor unit of the monitoring system of FIG. 1 attached to the dust cap.

FIG. 11 is a perspective view of the sensor unit of FIG. 1 separated from a dust cap seal and the dust cap.

FIG. 12 is a side view of the sensor unit of FIG. 10.

FIG. 13 is a top view of the sensor unit of FIG. 1 attached to the dust cap.

FIG. 14 is a cross-sectional view of the sensor unit and dust cap taken alone line 14-14 in FIG. 13.

FIG. 15 a perspective exploded view of the sensor unit of FIG. 10.

FIG. 16 is a flowchart of a method for monitoring a wheel hub.

FIG. 17 is a flowchart illustrating another method of using a monitoring system as disclosed herein.

### DETAILED DESCRIPTION

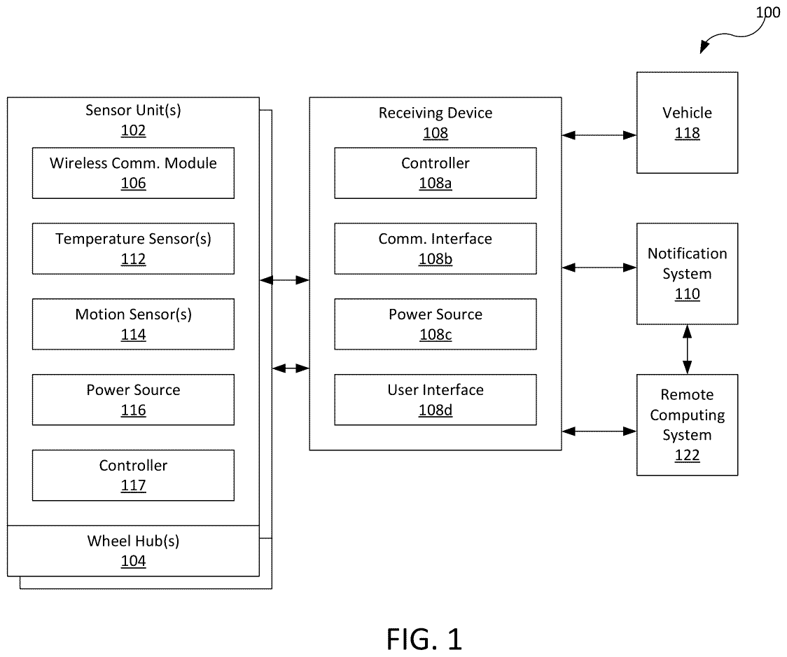

Referring to FIG. 1, a schematic illustration is provided of an exemplary monitoring system 100 for monitoring wheel hubs of trailers or vehicles. In operation, the sensor system 100 is configured to provide real-time monitoring of wheel hub 104 components and directly and indirectly related components such as bearings, brakes, tires, and suspension for identifying early warning signs of component issues to avoid failures. The vehicle monitoring system 100 is an advanced wireless temperature and motion sensor system that provides real-time monitoring of components for temperature and motion (e.g., vibration and/or rotation) anomalies, enabling timely detection and prevention of potential issues. Such anomalies may also be indicative of part failures, such as wheel separation, bearing failure, brake seizure, or tile failure. This not only improves safety but also allows for predictive maintenance through machine learning algorithms that track historical data including temperature extremes as well as miles traveled.

The monitoring system 100 includes one or more sensor units 102 and a receiving device 108. The monitoring system 100 may further include a notification system 110 and/or a remote computing system 122. Each of the sensor units 102 is configured to engage a wheel hub 104 of trailer or vehicle. For example, the wheel hub 104 may be at least one of the wheel hubs of a towable vehicle, such as an RV, travel trailer, enclosed trailer, race trailer, snowmobile trailer, and the like. As referenced above, the monitoring system 100 may include a plurality of sensor units 102, such that one of the sensor units 102 may be provided on each wheel hub 104 of the trailer or vehicle. The sensor unit 102 may be configured to sense temperature and/or motion (e.g., vibrations and/or rotation) of the wheel hub 104. The sensor unit 102 may be electronically connected to a wireless communication module 106, for example, by including the wireless communication module 106, for receiving and transmitting data collected from the sensor unit 102 to the receiving device 108. For example, the sensor unit 102 may be configured to receive data from the wheel hub 104 (e.g., sensing the characteristics of the wheel hub 104 and outputting related data), including data such as temperature and motion (e.g., vibration patterns and/or rotation).

In some examples, the sensor unit 102 may include one or temperature sensors 112, one or more motion sensors 114, the wireless communication module 106, a power source 116 (e.g., a battery), and a controller 117.

The one or more temperature sensors 112 sense temperature of the wheel hub 104 and may further sense another temperature (e.g., ambient). The temperature sensors 112 may, thereby, be used to create a comprehensive profile of temperatures across a wheel hub 104 in different locations to detect anomalies and increased temperature outside of temperature criteria in specific locations which may indicate component failure. For example, the sensor unit 102 may include one temperature sensor 112 (e.g., a thermistor) that is configured to sense the temperature of the wheel hub 104 (e.g., radiant heat by being positioned in close proximity thereto, as discussed in further detail below). The sensor unit 102 may further include another temperature sensor 112 (e.g., another thermistor) that is configured to sense the temperature in regions away from the wheel hub 104 (e.g., being oriented to face away therefrom and/or with other components therebetween), such as ambient temperature (e.g., of the environment) or in another contained volume positioned away from the wheel hub 104 (e.g., within a shroud or cover that contains both a dust cap of the wheel hub 104 and the sensor unit 102).

The sensor unit 102 itself (e.g., with the controller 117 thereof) and/or the receiving device 108 may be configured to determine whether one or more temperature criteria are met, which may indicate a problematic condition. In one example, a temperature criterion may be a threshold (e.g., a threshold temperature criterion or absolute temperature criterion), which is a fixed value. In another example, a temperature criterion may be a differential, which is a temperature difference relative to another temperature. The other temperature may, for example, be measured by the other temperature sensor 112 (e.g., ambient temperature). In this case, the temperature differential may be considered a real-time temperature differential criterion, since the differential is determined between two real-time (i.e., current or contemporaneously) temperature measurements. The other temperature may, for example, be the temperature of the wheel hub 104 measured at a previous time or over a previous period (e.g., in the same or similar circumstances, such as a similar wheel speed sustained over a similar duration with similar ambient temperatures). In this case, the temperature differential may be considered a baseline temperature differential criterion, since the differential is determined between the current temperature of the wheel hub 104 and a previous temperature (e.g., baseline temperature) of the wheel hub 104.

Instead or additionally, a temperature criterion may be a temperature rate criterion. In this case, the controller 117 determines a rate of temperature change from the temperature sensor data, or a change in temperature over a predetermined amount of time, that is compared to the temperature rate criterion. If the temperature rate criterion is exceeded, the rate of temperature change may indicate an abnormal high friction condition prior to another temperature criterion being met (e.g., potentially preempting an event harmful to the wheel hub 104).

The one or more temperature criteria may, for example, be predetermined (e.g., as provided by the manufacturer), user-defined, or learned temperature (e.g., based on historic temperature data).

The sensor unit 102 may include one or more of the motion sensors 114 that sense motion of the wheel hub 104, which may include vertical motion (e.g., suspension travel of the wheel to which the wheel hub 104 is attached) and/or rotational motion (e.g., rotations of the wheel to which the wheel hub 104 is attached). The motion sensor 114 is configured to measure linear and/or rotational acceleration and velocity and may, for example, be an accelerometer, velocity sensor, displacement sensor, or inertial measurement unit (IMU).

The motion sensors 114 may be used to create a comprehensive profile of motion across the wheel hub 104 in different locations to detect anomalies and motion characteristics which may indicate component failure, for example, according to one or more motion criteria. The sensor unit 102 itself (e.g., with the controller 117 thereof) and/or the receiving device 108 may be configured to determine whether one or more of the motion criteria (e.g., vibration or rotation) are met, which may indicate a problematic condition. Each vibration criterion is established to distinguish between normal vibrations and potentially-problematic vibrations. Normal vibrations, may, for example, be from normal road conditions (e.g., having a low magnitude and extended duration), or from road disturbances such as a pothole (e.g., having high magnitude and short duration). A normal road disturbance may, for example, induce a peak magnitude (i.e., acceleration) that is below a threshold value and dissipates over few subsequent periods (e.g., wheel rotations) and therefore, a very short duration. Problematic vibrations have higher magnitude, which may be expressed as a threshold value and/or a differential relative to normal road conditions that are sustained over a long duration. The one or more vibration criteria may be predetermined, user-defined, or learned as described previously. One vibration criterion may, therefore, include a magnitude criterion (e.g., 0.25 g or greater) and a duration criteria (e.g., 10 seconds, 1 minute, 5 minutes, 10 minutes, or more), both of which need to be satisfied for detection vibration anomalies (e.g., together forming a sustained vibration criterion). Other problematic vibrations may include a peak input that is particularly high but not sustained over time (e.g., a pulse input). In such case, a vibration criterion may be a peak magnitude criterion irrespective of duration (e.g., a pulse vibration criterion, which is of higher magnitude than the sustained vibration criterion if both are provided). Other problematic vibrations may include unexpected frequencies at a given rotational velocity (e.g., wheel speed). In such case, a vibration criterion may be a frequency differential criterion (e.g., vibration signature criterion), which is a differential between the measured vibration frequency and an expected frequency for a corresponding wheel speed (e.g., as measured previously with the motion sensor 114).

The motion criteria may also include rotation (e.g., rotational velocity or wheel speed) criteria, such as a differential speed criterion or a stopped wheel criterion. The one or more motion sensors 114 of the sensor unit 102 may be further configured to determine rotational speed of the wheel hub 104 and, thereby, the wheel to which the wheel hub 104 is coupled. For example, the sensor unit 102 itself (e.g., the controller 117 thereof) and/or the receiving device 108 may be configured to determine rotational velocity from acceleration measured by the one or more motion sensors 114 or from a direct measure of rotational velocity from the motion sensor 114. As discussed below, satisfaction of a differential speed criterion between different wheels may indicate wheel hub or brake problem. The differential speed criterion may be satisfied if the wheel speed determined with one sensor unit 102 is different than the wheel speed determined with other sensor units 102 (e.g., on the same side of a trailer or across all wheels) by a margin greater than the differential speed criterion at any given time and/or over a duration (e.g., to account for vehicle turning and momentary brake lock up).

Similar to the temperature rate criterion, the monitoring system 100 may be configured to identify abnormal conditions or anomalies based on a rate of motion change (e.g., vibration or magnitude rate of change, or rotational velocity rate of change), which may be compared to motion rate of change criterion (e.g., vibration rate change criterion, vibration magnitude criterion, or rotational acceleration criterion).

The motion sensor 114 may be configured to detect rotational characteristics of the wheel assembly including rotational frequency, changes in rotational frequency, or loss of rotational motion indicative of wheel lock, bearing seizure, or brake drag conditions. To detect such conditions, a stopped wheel criterion may be satisfied if the rotational velocity is below a given threshold (e.g., equal to zero).

The sensor unit 102 includes or may be connected to the power source 116 for operating the sensor unit 102. For example, the sensor unit 102 may include a battery that forms the power source 116 and which provides power to at least the temperature sensor 112, the motion sensor 114, the wireless communication module 106, and the controller 117. In other examples, the sensor unit 102 may include a power source 116 that is more energy-efficient such as utilizing solar power or kinetic energy harvesters. These power sources 116 may extend the operational life of the sensor unit 102 and reduce the need for frequent battery replacement, making it an ideal option for long-distance towing and towing in remote locations. The monitoring system 100 may also allow a user to select a transmit power level to balance network coverage and energy efficiency, thus allowing a user to customize and incorporate energy-saving into the monitoring system 100 when possible.

The wireless communication module 106 transmits data from the wheel hub 104 to the receiving device 108. The wireless communication module 106 may, for example, include a radio that is configured to transmit and/or receive date from and/or to, respectively, the sensor unit. The radio may be configured according to any suitable standard, such as Bluetooth Low Energy (BLE). The wireless communication module 106 of each of the sensor units 102 may also include a wireless repeater, or function as a repeater, to extend the communication range between the sensor unit 102 and the receiving device 108. For example, the wireless communication module 106 of one of the sensor units 102 transmits data that is received by the wireless communication module 106 of another of the sensor units 102 positioned closer to the receiving device 108, which, in turn, transmits the data from the one sensor unit 102 and itself (i.e., the closer sensor unit 102) to the receiving device 108.

The controller 117 is configured to operate the sensor unit 102, including the one or more temperature sensors 112, the one or more motion sensors 114, the power source 116, and the wireless communication module 106. The controller 117 may, for example, be any computing device or unit capable of operating the foregoing components in the manners described below. For example, the controller 117 may include a processor (e.g., a central processing unit), a memory (e.g., a short-term volatile memory), a storage (e.g., a long-term, non-volatile memory), a communications interface (e.g., by which signals are received to/from the controller 117), and a bus (e.g., by which the components of the controller 117 communicate with each other). The controller 117 is configured to operate the various components of the sensing unit 102 in the manner described herein (e.g., according to programming or other instructions stored thereby, such as in the storage or other computer readable medium), as well as analyze temperature and/or motion data as described herein. The controller 117 may have any other suitable hardware configuration.

The controller 117 may be configured to operate the sensor unit 102 in different operational states, process the data sensed by the temperature sensors 112 and/or the motion sensors 114, and cause the wireless communication module 106 to send various data to the receiving device 108.

In one example, the controller 117 is configured to operate the sensor unit in at least a first state and a second state. In the first state, which may also be referred to as a low power or sleep state, the controller 117 is configured to operate the sensor unit 102 to consume energy at a low rate, for example, by operating only one of the motion sensors 114 to detect motion but not the temperature sensors 112 or the wireless communication module 106. To further reduce power consumption in the first state, the controller 117 may be configured to operate the motion sensor 114 at reduced sampling frequencies and/or spaced apart sampling periods compared to the second state (e.g., a sampling rate of 10, 5, or 1 Hz or less as compared to a sampling rate of 20, 30, 60 Hz or more in the second state, and/or with sampling periods that are spaced apart by 10, 30, 60, seconds or more, as opposed to continuous sampling). Upon detecting motion while in the first state, the controller 117 may begin operating the sensor unit 102 in the second state.

In the second state, which may be referred to as a normal power or operational state, the controller 117 is configured to operate the temperature sensors 112, the motion sensors 114, and the wireless communication module 106. In the second state, the sensor unit 102 consumes energy at a faster rate than in the first state. In the second state, the controller 117 is configured to operate the temperature sensors 112 at suitable sampling rates (e.g., 1, 5, 10 Hz or more) continuously and to also operate the motion sensors 114 at greater sampling rates and/or with closer sampling periods than in the first state (e.g., 20, 30, 60 Hz or more continuously, as referenced above). In the second state, the controller 117 is additionally configured to operate the wireless communication module 106 to transmit data (e.g., temperature, motion, and other data) to the receiving device 108, for example, transmitting the data in packets at intervals spaced apart by 1, 2, 5, 10, 30, or 60 seconds or more. In the second state, the controller 117 may be further configured to analyze the temperature data and/or the motion data, for example, against the one or more temperature criteria and/or the one or more movement criteria (e.g., vibration or rotation) described previously. If such criteria are exceeded, the controller 117 may send an alert signal to the receiving device 108 indicative of the problematic criterion having been met and/or may start operating in a third state. The sending of an alert signal between components or devices and/or the output of an alert to a user (e.g., with a user interface) may both be referred to as providing or outputting an alert.

The sensor unit 102 may be further configured to operate in the third state, for example, if any of the temperature and/or motion criteria are met. In the third state, which may be referred to as a high power or alert state, the controller 117 continues operation of the temperature sensors 112, the motion sensors 114, and the wireless communication module 106.

In the third state, the controller 117 consumes energy at a faster rate than in the first state and in the second state, for example, by causing the wireless communication module 106 to transmit the data at closer intervals than in the second state, for example, substantially continuously (e.g., at intervales spaced apart at 5, 4, 3, 2, 1 second or less). In the third state, the sensor unit 102 may be configured operate the temperature sensors 112 and/or the motion sensors 114 in the same manner as in the second state or with increased sampling rate.

In any of the states, the sensor unit 102, when analyzing data collected by the temperature sensors 112 and/or the motion sensors 114 may operate in an isolated manner relative to other sensor units 102, for example, by comparing the temperature data and the motion data collected thereby only to temperature criteria and/or motion criteria intrinsic to the sensor unit 102 itself and not in any manner relative to (i.e., irrespective of) the temperature data and/or motion data measured by another of the sensor units 102.

The receiving device 108 is configured to receive, process, store and/or transmit the temperature data, the vibration and/or motion data, and/or other data (e.g., alert signals) from the one or more sensor units 102. The receiving device 108 may be further configured to provide information to a user (e.g., a temperature or motion information, status, or alerts). The receiving device 108 may, for example, generally include a controller 108a, a communications interface 108b, and a power source 108c, and may further include a user interface 108d. The controller 108a may have the hardware configuration as generally described for the controller 117. The communications interface 108b is configured to receive data signals from the wireless communication module 106 of the sensor units 102 (e.g., using a common standard, such as BLE) and may be further configured to communicate to the notification system 110 and/or the remote computing system 122 in any suitable manner with further suitable hardware components (e.g., BLE, Wi-Fi, or cellular communications standards and capable radios). The power source 108c may be any suitable power source, which may include that of the vehicle. The user interface 108d may, for example, include a touch screen and/or other visual or audible outputs by which information and/or alerts are provided to the user. The user interface 108d may be further configured to receive inputs from the user.

The receiving device 108 may be electronically connected to a notification system 110 for communicating the anomalies to a vehicle operator to notify the operator of a potential component failure of the wheel hub 104. The notification system 110 may be at least one of a mobile device, such as smartphone or tablet computer, or a vehicle head unit, which is a user interface that outputs information to a user and may receive inputs therefrom (e.g., via a touch screen or voice inputs via a microphone). For example, the notification system 110 may include an application for a mobile device which may notify a vehicle operator of a potential failure. In another example, the notification system 110 may include a device or connection to the vehicle which notifies the vehicle operator of a potential failure through a vehicle head unit. In other examples, the notification system 110 may be a different device in the vehicle or connected to an external device. In some examples, the receiving device 108 may omit the user interface. In other examples, the notification system 110 (e.g., a mobile device or vehicle head unit) may also function as the receiving device 108.

Once the temperature and/or motion data is collected and transmitted to the receiving device 108, the receiving device 108 is configured to analyze the temperature data and the motion data for anomalies and/or to alert the user as to any such anomalies. Collection of two data types (i.e., temperature and motion) which are associated with component failure may reduce false positives that may be associated with only one data type (i.e., temperature or motion alone). For example, if temperature data is collected that is abnormal, cross-referencing with the collected motion data may indicate if a component is failing or if the temperature is reported as abnormal for another reason not associated with component failure. In order to assess temperature and motion (e.g., vibration and/or rotation data) in conjunction with each other, or with even further data (e.g., vehicle or environmental data), the monitoring system 100 may employ sensor fusion (e.g., using Kalman filters or other algorithms).

However, the monitoring system 100 may be configured to analyze a temperature criterion independent of motion data (e.g., as a standalone temperature criterion) and/or to analyze a motion criterion independent of temperature (e.g., as a standalone motion criterion). Moreover, the monitoring system 100 may even include only one type of the sensors (i.e., the temperature sensors 112 or the motion sensors 114 of the sensor unit 102).

The receiving device 108 may analyze the temperature and/or the motion data in isolated manners (i.e., individually for each of the sensor units 102 against temperature and/or motion criteria irrespective of any of the other sensor units 102).

Sensor data from multiple sensor units 102 associated with different hubs 104 may be compared by the monitoring system 100 (e.g., one of the sensor units 102 or the receiving device 108) to detect abnormal operating conditions including temperature differentials, vibration anomalies, or rotational differences between wheels of the same trailer axle or vehicle. In examples where a sensor unit 102 is provided on more than one wheel hub 104 of the towable vehicle, the receiving device 108 may be configured to compare the temperature data and/or the motion data from one of the sensor units 102 coupled to one wheel hub 104 to that from one or more other sensor units 102 coupled to each of one or more of the other wheel hubs 104. For example, the receiving device 108 may be configured to detect anomalies (e.g., overloading or other criteria) of the wheels on one specific axle or across different axles when temperatures of one wheel exceed temperatures of other wheels on the same axle or across the different axles. In such a case, the temperature and/or motion (e.g., vibration and/or rotation) criteria may be a differential, which may be referred to as a relativistic differential temperature, vibration, or rotation criterion by comparing two different sensor units 102). For example, the temperature of one wheel may exceed an average temperature of the other wheels on the axles or across multiple axles by a temperature criterion (e.g., a temperature differential relative to the average or a temperature threshold based on the average temperature, which may be referred to as the relativistic temperature criterion). In another example, the magnitude and/or frequency of vibration measured by one sensor unit 102 may exceed that measured by another of the sensor units 102 by a magnitude and/or frequency criterion, which may be referred to as a relativistic vibration criterion. In a further example, the rotational velocity (e.g., wheel speed) measured by one sensor unit may be less than that measured by another of the sensor units 102 by a rotational velocity criterion (e.g., indicating an abnormal braking or friction condition), which may be referred to as a relativistic motion criterion or rotational periodicity criterion.

In other examples, the receiving device 108 may include a processor capable of storing historical data (e.g., in the storage of the controller 108a). The receiving device 108 may also compare the temperature data and the motion data from the wheel hubs 104 against historical data collected from the same or different sensor units 102 associated with different wheel hubs 104 to detect anomalies in particular wheels and/or for maintenance purposes. Thus, the real-time data collected from sensor unit 102 of one wheel hub 104 may be compared and analyzed to one or both of real-time data collected from the same sensor unit 102 and/or the sensor units 102 of one or all of the other wheel hubs 104. The monitoring system 100 may also integrate machine learning algorithms pre-trained on wheel hub failure data and may continuously refine its model based on user-specific data and historical data. The algorithm identifies abnormal trends by comparing real-time sensor data to historical patterns, offering notifications and early warnings of potential issues with increasing accuracy over time.

The receiving device 108 may be configured to communicate with vehicle systems 118. For example, the receiving device 108 may be able to communicate with a vehicle head unit to provide real-time notifications to a vehicle operator of potential failures, along with real-time temperature and motion data.

In other examples, the receiving device 108 may be configured to communicate with other vehicle systems 118 to receive additional vehicle data for analysis. For example, the receiving device 108 may be configured to communicate with vehicle systems 118, such as a tire pressure monitoring system and the onboard diagnostics to integrate tire pressure data associated with the tires on the wheels and other relevant information with the temperature and motion data. The receiving device 108 may receive or track trailer mileage using the motion sensor 114 and/or the vehicle systems 118 (e.g., odometer), utilizing a calibration process or algorithm for accurate mileage estimation and suggesting optimal intervals for preventive maintenance of wheel bearings and brakes. Additional data and information retrieved from the vehicle systems 118 may provide a more comprehensive data profile that increases the algorithm's ability to offer notifications and early warnings of potential issues. The receiving device 108 may also be further configured to assist with trailer leveling during setup by comparing side-to-side accelerometer data utilizing sensors on two or more wheels (e.g., accelerometers) as part of the wheel hub 104 or another of the vehicle systems 118.

The notification system 110 may be configured to provide customizable and user-specific notifications. The notification system 110 may provide visual or audio alerts to a vehicle operator when the monitoring system 100 detects abnormal temperature differentials or motions satisfying various criteria, indicating potential issues with a bearing, brake, tire, or suspension determined by temperature data, motion data, or a combination thereof. Moreover, the notification system 110 may be configured to receive user-provided criteria and notification preferences. Thus, criteria may be input by a user such that notifications are not received unless the temperature differentials or motion (e.g., vibration or rotation) exceed the criteria as set by the user for their particular towing setup.

The receiving device 108 may be further configured to store the data in conjunction with other data, for example, global positioning system data (e.g., GPS data), speed data, temperature data, load data (e.g., weight), type of trailer or other data that may be input to the receiving device 108 directly and/or received from other devices (e.g., the notification system 110 and/or the vehicle systems 118).

The receiving device 108 may be further configured to communicate with the remote computing system 122, directly or indirectly (e.g., via the notification system 110 and radios thereof). The remote computing system 122 is a computing device or system configured to receive, store, and/or analyze any of the foregoing data (e.g., temperature, vibration, rotation, and the foregoing other information) for different monitoring systems 100 (e.g., associated with different trailers and/or vehicles). The remote computing system 122 may, for example, be configured to communicate alerts to other devices associated with the monitoring system 100 (e.g., to the device of a manager or owner of a fleet of trailers). The remote computing system 122 may, for example, be configured to analyze the data received from the different monitoring systems 100 (e.g., the different sensor units 102) thereof (e.g., against the different criteria described previously) and/or to develop different sensing algorithms and/or anomaly detection criteria (e.g., via machine learning algorithms).

The receiving device 108 may be further configured to initialize and/or update a monitoring system 100 and/or the sensor units 102 thereof. When initializing a monitoring system 100, the receiving device 108 establishes a group of the sensor units 102 and assigns each of the sensor units 102 to one of the wheel hubs 104 of the trailer or vehicle. Initializing the monitoring system 100 may further include integrating a new sensor unit 102 into an existing monitoring system 100, for example, by replacing a damaged sensor unit 102 with an undamaged sensor unit 102. When adding a different one of the sensor units 102 to a monitoring system 100, the receiving device 108 may identify the added sensor unit 102 according to greater signal strength (e.g., since the other sensor units 102 may already be coupled to the wheel hubs 104, while the added sensor unit 102 is not yet coupled to a wheel hub 104 and may be positioned nearer to the receiving device 108). Updating the monitoring system 100 may, for example, include receiving updated software or firmware for the receiving device 108 and/or the sensor units 102. In the case of updated software or firmware for the sensor units 102, the receiving device 108 may transmit the updated firmware or software or firmware to the sensor units 102 of the monitoring system 100.

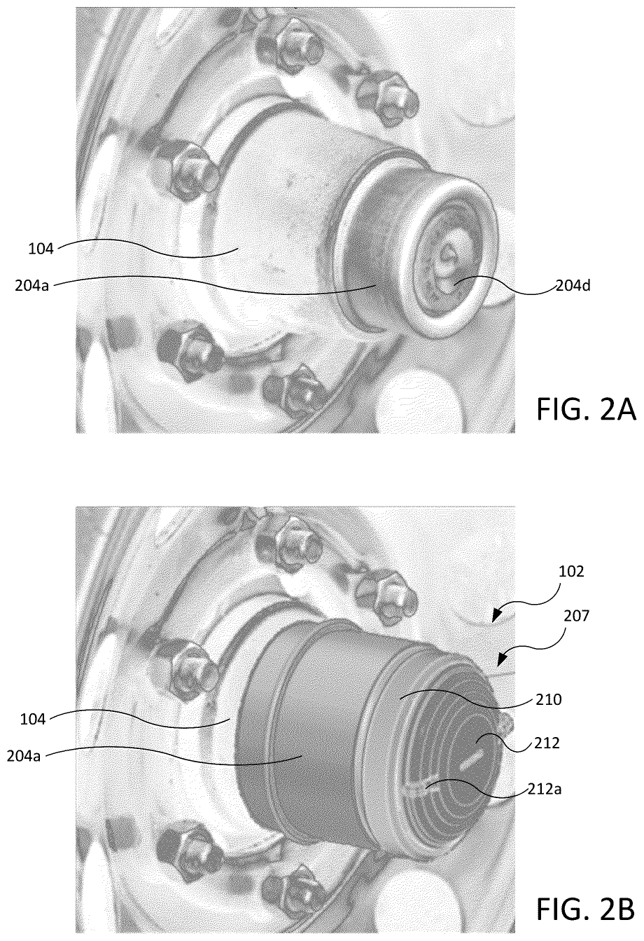

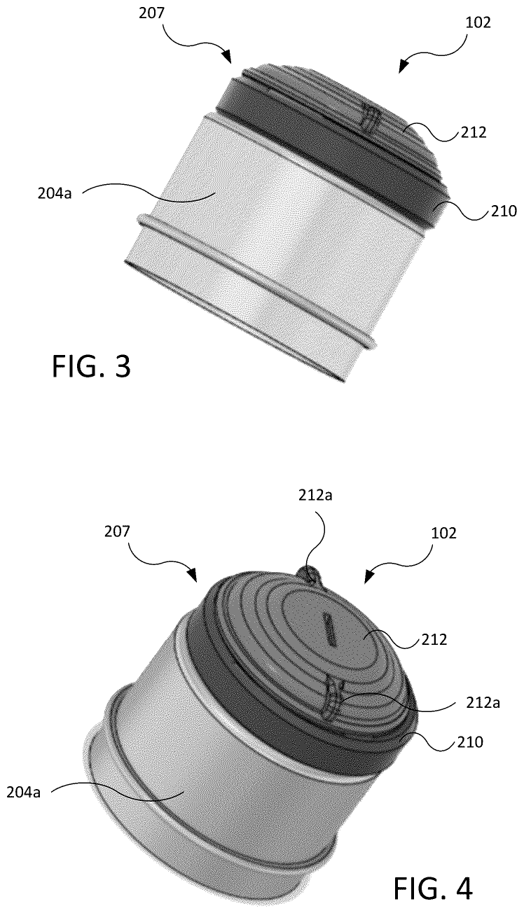

Referring to FIGS. 2A-4, the sensor unit 102 is configured to couple to or otherwise engage with a wheel hub 104. More particularly, a conventional wheel hub 104 includes a dust cap 204a positioned thereover. The dust cap 204a is generally configured to inhibit dust and debris from entering the wheel hub 104. The dust cap 204a is a generally hollow cylinder in which is received a portion of the wheel hub 104. An outer end of the dust cap 204a extends radially inward and defines an opening 204b that is normally closed with a removable seal 204d and which provides physical access to the wheel hub 104, for example, to a grease fitting that is configured to receive grease into the wheel hub 104 (e.g., for greasing the bearings therein). The dust cap 204a may also be covered by a wheel center cap (not shown) that receives therein and couples to an outer circumferential surface of the dust cap 204a. The wheel center cap may define an empty space therein positioned axially outward of the dust cap 204a, while the sensor unit 102 is configured to be contained within the empty space within the wheel center cap.

The sensor unit 102 may be integrated with or otherwise configured to engage or couple to the dust cap 204a of the wheel hub 104. While the dust cap 204a may be modified relative to conventional dust caps 204a to receive and couple to the sensor unit 102, the sensor unit 102 is preferably configured to couple to conventional versions of the dust caps 204a, which typically include openings 204b of a standard diameter. More particularly, the sensor unit 102 includes a sensor housing 208 and a seal 210 (e.g., a dust cap seal). The seal 210 is a compliant structure (e.g., made of rubber or other elastomer) configured to couple to the dust cap 204a and, in particular, to the opening 204b thereof. The sensor housing 208 is configured to interface with the seal 210 (e.g., couple thereto), such that the sensor unit 102 sits inside the circumference of the seal 210 (e.g., being surrounded by the seal 210 and the material of the dust cap 204a that defines the opening 204b).

The sensor unit 102 includes an enclosure 207 having a sensor housing 208 and a sensor cover 212. The sensor housing 208 is a generally rigid structure that is configured to contain the sensors and other electronic component therein (e.g., the temperature sensors 112, the motion sensor 114, the power source 116, and the controller 117). For example, the sensor housing 208 may be a generally concave structure that defines a volume in which the sensors and electronic components are positioned. A sensor cover 212 of the sensor unit 102 engages the sensor housing 208 to form the enclosure 207 for containing internal components of the sensor unit 102, for example, forming a seal therewith. The sensor cover 212 may include handles 212a or other grip locations to assist a user with installing and/or uninstalling the sensor unit 102 in the dust cap 204a and/or for coupling the enclosure 207 to the seal 210 (e.g., via rotation). For example, the sensor unit 102 may be force fit into the circumference of the dust cap 204a, for example, with an interference fit into the seal 210. The handles 212a may provide a location on the sensor cover 212 to push and/or pull the sensor unit 102 into and out of place. In an alternative embodiment, the enclosure 207 (or the enclosure 1007 of the sensor unit 1002 discussed below) may be configured to form and replace the dust cap 204a and couple directly to the hub 104. Further, while the sensor unit 102 has been physically described as coupleable to the dust cap 204a as an aftermarket component, the sensor unit 102 may be incorporated with the hub 104 by the hub or trailer manufacturer and include components and be operated in the manners described herein.

In some examples, the seal 210 may be interchangeable or adjustable to accommodate various wheel hubs and sizes of dust caps 204a. For example, the seal 210 may be configured to accommodate common Dexter and Lippert axle hubs. The seal 210 may be formed of high-durability flexible materials to ensure compatibility with different bearing diameters and allow for easy installation across various trailer types. In other examples, the seal 210 and sensor unit 102 may be installed via clamps or other attachment methods when in use with standard bearing protectors. In examples, the seal 210 may be configured to be installed in the internal circumference of the bearing protector without engaging with or affecting the pressure relief features of the bearing protector. The sensor unit 102 may be removed and reinstalled with ease to allow easy accessibility to grease fittings in the bearing protector.

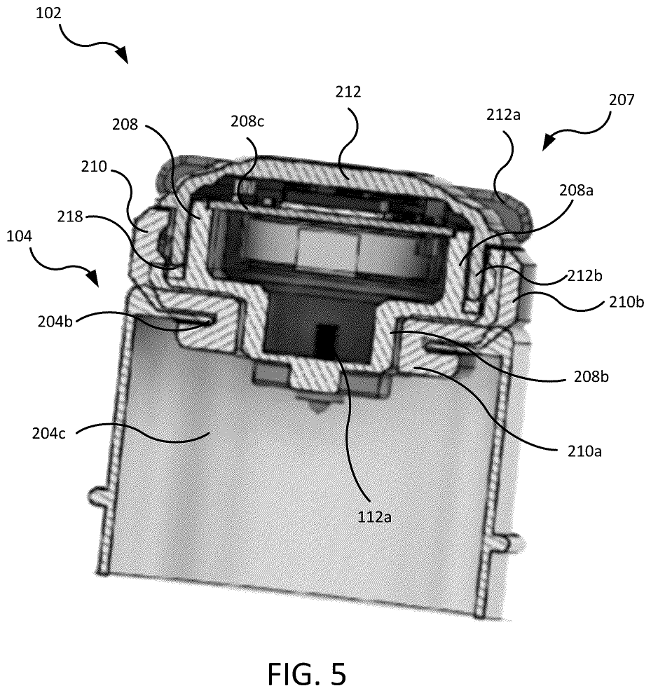

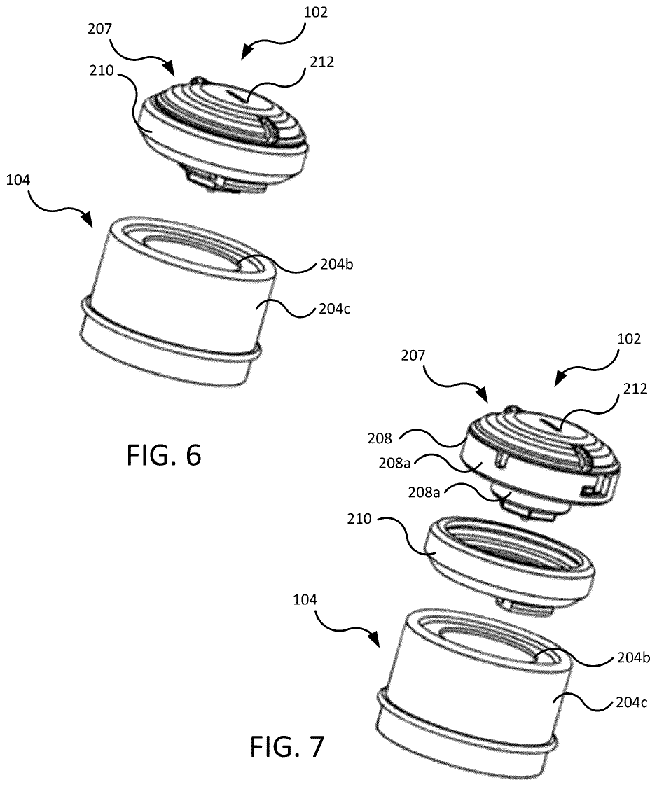

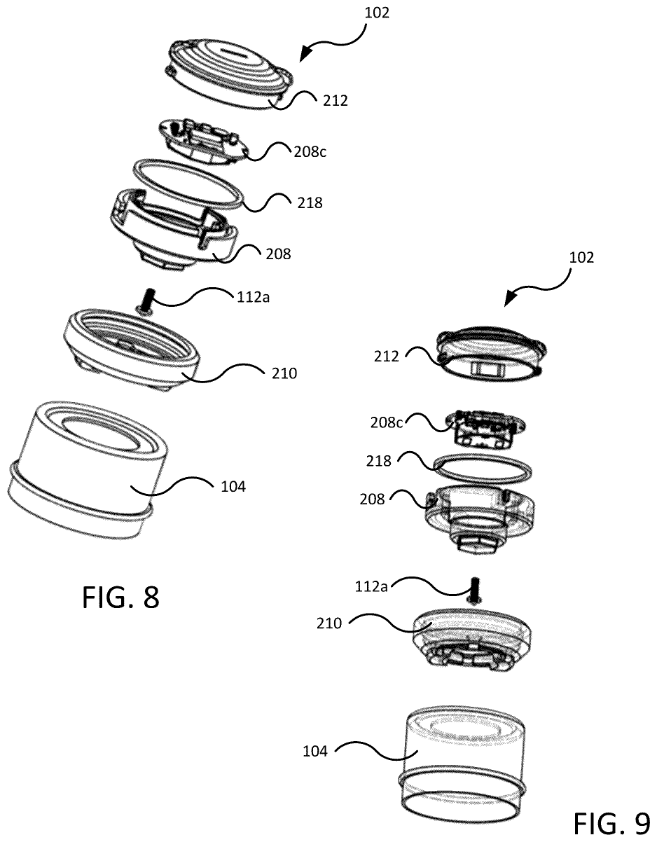

Referring to FIGS. 5-9, the structure and physical features of the sensor housing 208, sensor cover 212, and the seal 210 of the sensor unit 102 are described in further detail. FIG. 5 illustrates a cross-sectional view of the sensor unit 102. FIG. 6 illustrates an exploded view of the sensor unit 102 and the dust cap 204a. The sensor unit 102 is further expanded in FIG. 7 to illustrate the sensor housing 208 and the seal 210. FIGS. 8 and 9 are further expanded views illustrating the interior components of the sensor unit 102.

The dust cap 204a includes a circular body 204c having the opening 204b in the top surface for receiving a seal 210 in use with the sensor unit 102. The dust cap 204a might otherwise be configured to receive a center plug or removable seal 204d for sealing the opening 204b when not in use with the sensor unit 102. The seal 210 is generally configured as a grommet or other type of seal that extends around the inner periphery of the opening 204b of the dust cap 204a to form a seal therewith. The seal 210 generally includes an inner portion 210a and an outer portion 210b. In this case, the terms inner and outer refer to axial positions relative to the dust cap 204a (i.e., inner meaning axially closer to or further within an inner volume of the dust cap 204a, and outer meaning axially further from or further outside the inner volume of the dust cap 204a). The inner portion 210a extends axially from the outer portion 210b and may be coaxial therewith. The inner portion 210a is generally configured to engage the portion of the circular body 204c surrounding the opening 204b of the dust cap 204a to form a seal therewith. For example, as shown, the inner portion 210a generally includes an inner flange and an outer flange that are spaced apart axially and connected by an intermediate segment. The inner flange and the outer flange extend radially outward along and seal against inner and outer surfaces of the dust cap 204a immediately surrounding the opening 204b, while the intermediate segment engages or is in close proximity with the periphery of the opening 204b of the dust cap 204a. The outer portion 210b of the seal 210 extends axially from the inner portion 210a (e.g., an outer periphery of the outer flange) and is coaxial therewith and has a larger diameter. Each of the outer portion 210b and the inner portion 210a of the seal 210 are configured to receive portions of the enclosure 207 of the sensor unit 102 (e.g., the sensor housing 208 and/or the sensor cover 212) therein and may form a seal and/or interference fit therewith to both prevent intrusion of debris into the dust cap 204a and to retain the enclosure 207 of the sensor unit 102 to the wheel hub 104.

More particularly, the sensor housing 208 includes a first portion 208a (e.g., an outer portion) and a second portion 208b (e.g., an inner portion). In this case, inner and outer also refer to axial positions relative to the dust cap 204a, as was described for the seal 210 above. The first portion 208a may be a round casing having a larger circumference than the second portion 208b and a coaxial relationship therewith. The first portion 208a and the second portion 208b are coupled to or integrally formed with each other and may define a continuous inner volume in which the electronics are positioned. The first portion 208a may be configured to house a circuit board 208c and battery (e.g., the power source 116) of the sensor unit 102. The temperature sensors 112, the motion sensors 114, the power source 116, and the controller 117 may each be coupled to the circuit board 208c. In the case of the sensor unit 102 including two of the temperature sensors 112, a first of the temperature sensors 112 may be arranged nearer the wheel hub 104 (e.g., being arranged to an axially inner side of the circuit board 208c and/or within the volume defined by the second portion 208b). A second of the temperature sensors is arranged further from the wheel hub 104 (e.g., being arranged to an axially outer side of the circuit board 208c within he volume defined by the first portion 208a and/or the sensor cover 212).

The second portion 208b may be configured to engage and/or form a seal with the seal 210 of the dust cap 204a, for example, being received axially and compressed radially therein. The second portion 208b may be provided with a circumference configured to fit in the opening 204b of the dust cap 204a in a force fit manner and/or form a seal therewith, for example, being compressed radially therein to both prevent intrusion of debris into the dust cap 204a and to retain the enclosure 207 of the sensor unit 102 to the wheel hub 104. The second portion 208b is configured to protrude through the opening 204b of the dust cap 204a, together with the seal 210 replacing the center plug of the dust cap 204a.

The sensor cover 212 engages and may form a seal with the sensor housing 208 to enclose the sensor unit 102 to protect the circuit board 208c and other internal components (e.g., the wireless communication module 106, the temperature sensors 112, the motion sensors 114, the power source 116, and the controller 117). For example, the first portion 208a of the sensor housing 208 may define a circumferential channel (not labeled) between two axially-extending circumferential flanges in which is received a circumferential flange 212b of the sensor cover 212 to form a coupling and/or seal therewith and, thereby, seal the sensor housing 208. The sensor unit 102 may include a sensor seal 218 (e.g., gasket) positioned axially between the sensor cover 212 and the sensor housing 208 to provide a waterproof and tight seal to further protect the internal components.

The circuit board 208c may include or be connected to at least one temperature sensor 112 configured to detect the temperature of wheel components in real-time. In some examples, the temperature sensor 112 may be a thermistor 112a that extends inward into the opening 204b of the dust cap 204a. For example, the thermistor 112a may be in fluidic communication with an interior volume of the dust cap 204a. The thermistor 112a may be configured to receive temperature data (e.g., sense heat, such as radiant heat) from the wheel hub 104 and assist with assessing the thermal dissipation of the wheel hub 104. In other examples, the sensor unit 102 may include a plurality of temperature sensors 112 to create a comprehensive profile of temperatures across a wheel hub 104 in different locations to detect anomalies and increased temperature outside of temperature criteria in specific locations which may indicate component failure. As referenced above, while the thermistor 112a is positioned axially inward of the circuit board 208c, the second temperature sensor 112 (e.g., another thermistor) is positioned axially outward of the circuit board 208c.

Alternatively, the first, second, or only temperature sensor 112 may be positioned within the enclosure 207, mounted externally relative to the enclosure, or coupled to the enclosure 207 through a thermally conductive interface such that the temperature sensor 112 is in direct or indirect thermal communication with the wheel hub 104. The first, second, or only temperature sensor 112 may alternatively be configured to contact or be thermally coupled to a hub component including but not limited to a dust cap, hub body, spindle, grease fitting, fastener, or other metallic component of the wheel assembly. The temperature sensor may measure hub temperature through conduction, direct contact, indirect thermal coupling, or proximity-based sensing.

the thermistor 112a may be contained entirely within the enclosure 207 or may be positioned outside the enclosure 207 in another manner (e.g., being exposed to the environment surrounding the enclosure, or in physical contact with the dust cap 204a). The second temperature sensor 112 may be positioned, for example, being positioned outside the enclosure 207 to be exposed to the environment surrounding the enclosure, physical contact with the dust cap 204a, and/or exposed to ambient air).

As referenced above, the circuit board 208c may also include at least one movement sensor 114 coupled thereto, such as an accelerometer, velocity sensor, displacement sensor, or inertial measurement unit (IMU), and configured to detect vibration levels and vibration profiles of wheel components in real-time. In some examples, the sensor unit 102 may include a plurality of motion sensors 114 to create a comprehensive profile of vibrations across the wheel hub 104 in different locations to detect anomalies and vibration characteristics which may indicate component failure. It should be noted that the motion sensor 114 may be configured to measure other parameters instead of or in addition to vibrations (e.g., wheel rotations, gross movements, rotational velocity).

The circuit board 208c may also include or be electronically connected to the controller 117 and the wireless communication module 106 to transmit data collected from the sensor unit 102 to the receiving device 108. Once collected and transmitted to the receiving device 108, the receiving device 108 is configured to analyze the temperature data and the motion data to scan for the anomalies. Collection of two data types which are associated with component failure may reduce false positives that may be associated with only one data type. For example, if temperature data is collected that is abnormal, cross-referencing with the collected motion data may indicate if a component is failing or if the temperature is reported as abnormal for another reason not associated with component failure.

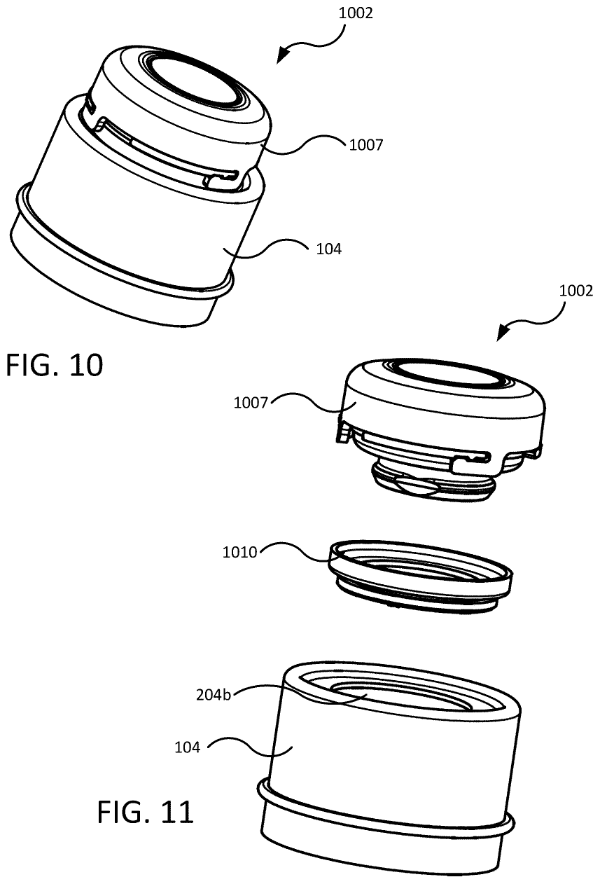

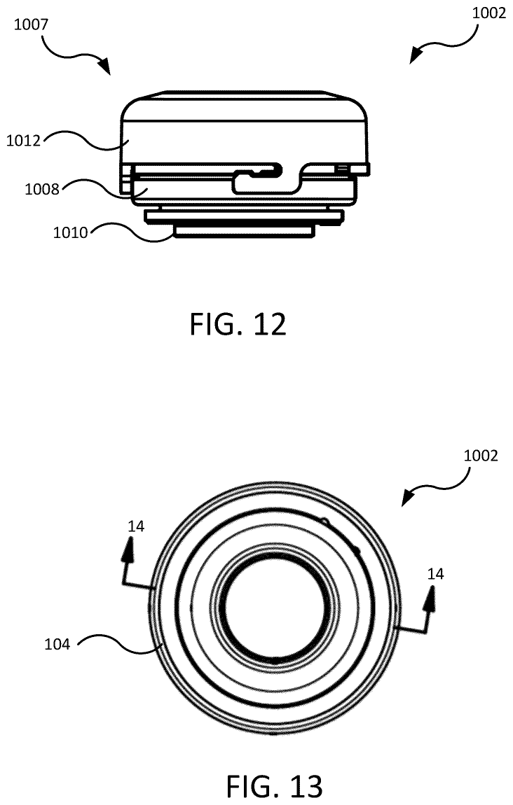

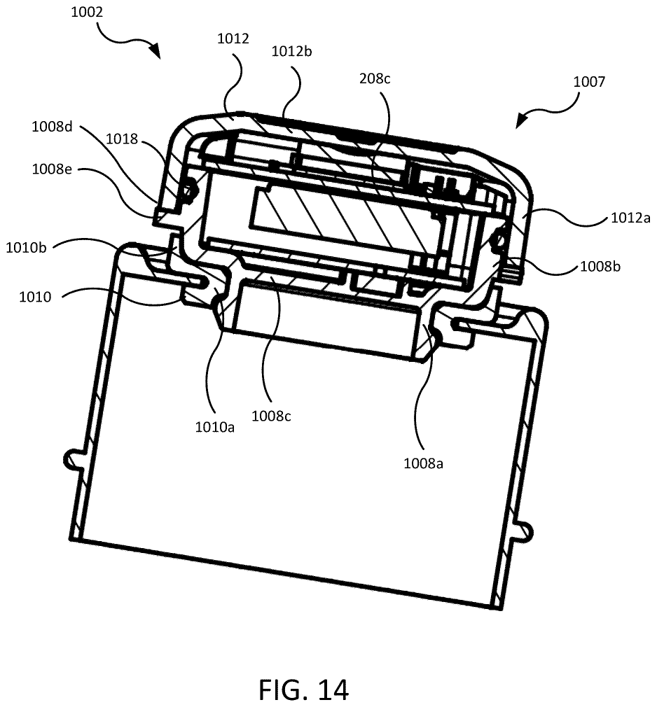

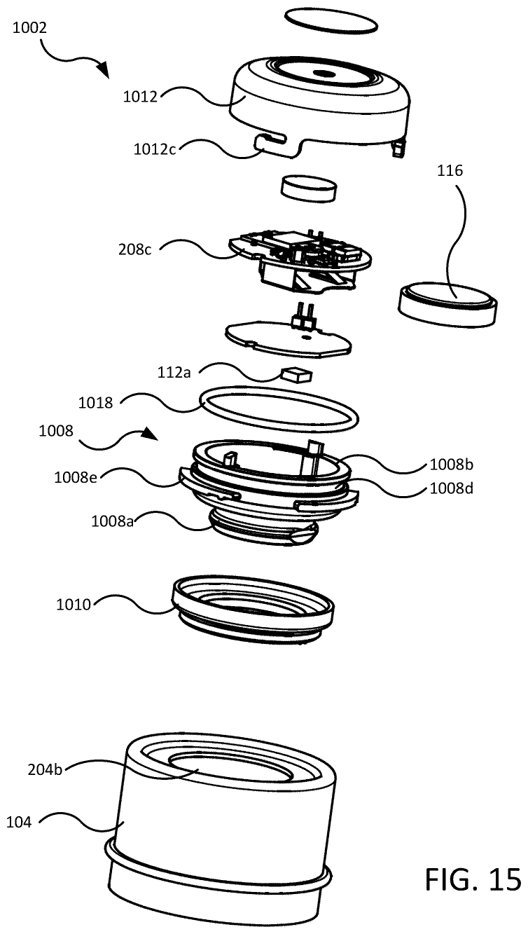

Referring to FIGS. 10-15, a sensor unit 1002 is a variation of the sensor unit 102 that includes an enclosure 1007 and a seal 1010 that are configured differently than the enclosure 207 and the seal 210 described with respect to FIGS. 2A-9. The sensor unit 1002 is otherwise configured as described with respect to FIG. 1 (i.e., having the wireless communication module 106, the temperature sensors 112, the motion sensors 114, the power source 116, and the controller 117). More particularly, the enclosure 1007 is configured to have a smaller diameter and/or axial length than the enclosure 207. The enclosure 1007 further defines an inner recess that may accommodate components of the wheel hub 104 contained within the dust cap 204a (e.g., a grease nipple).

The seal 1010 is generally configured as a grommet having an axially inner portion 1010a and an axially outer portion 1010b. The axially inner portion 1010a is configured similar to the inner portion 210a of the seal 210 by having an inner flange and an outer flange interconnected by an intermediate axial section. The inner and outer flanges of the inner portion 1010a extend radially outward along inner and outer surfaces of the dust cap 204a beyond the opening 204b. The axially outer portion 1010b extends axially outward from the outer flange. The outer flange of the inner portion 210a and the outer portion 210b are spaced radially inward from an outer periphery of the dust cap 204a.

The enclosure 1007 includes an inner housing 1008 and an outer cover 1012, which cooperative define a sealed volume that contains the circuit board 208c and the various electronic components coupled thereto (e.g., the wireless communication module 106, the temperature sensors 112, the motion sensor 114, the power source 116, and the controller 117).

The inner housing 1008 generally includes an inner portion 1008a, an outer portion 1008b, and a wall portion 1008c. The inner portion 1008a is generally cylindrical and defines an inner volume that is in fluidic communication with an interior of the dust cap 204a. The inner volume (e.g., recess) is configured to define a volume that may receive a component of the wheel hub 104 therein (e.g., the grease fitting). The inner portion 1008a is received axially by the axially inner portion 1010a of the seal 1010. The inner portion 1008a further defines a circumferential channel that receives the axially inner portion 1010a of the seal 1010 therein, so as to form a seal therebetween (to prevent debris from entering the dust cap 204a) and to retain the inner housing 1008 (and thereby the sensor unit 102) to the dust cap 204a.

The outer portion 1008b is generally cylindrical and includes an outer cylindrical wall 1008d that defines an outer volume that forms the sealed volume with the outer cover 1012 in which the electronic components are positioned. The outer portion 1008b extends axially outward and radially outward from the inner portion 1008a. The outer volume of the outer portion 1008b and the inner volume of the inner portion 1008a are fluidically separated by the wall portion 1008c. The outer portion 1008b further includes a segmented flange 1008e that extends radially outward at an axially inward position from the outer cylindrical wall. The segmented flange is configured to couple the outer cover 1012 to the inner housing 1008.

The outer cover 1012 generally includes an outer cylindrical wall 1012a and a radial portion 1012b that extends continuously across the outer cylindrical wall 1012a. An inner end of the outer cylindrical wall 1012a includes mating features 1012c that engage the segmented flange 1008e to couple the outer cover 1012 to the inner housing 1008. The enclosure 1007 further includes a seal 1018 (e.g., a gasket) that is compressed radially the outer cover 1012 and the outer cylindrical wall 1008d of outer portion 1008b of the inner housing 1008 to seal the interior volume of the enclosure 1007.

The outer cover 1012 may be configured to couple to the inner housing 1008 in other manners, for example, via a threaded interface.

The sensor unit 1002 may include the thermistor 112a as described previously, which may be in fluidic communication with an interior of the dust cap 204a, while also including a second temperature sensor 112 positioned on an outer side of the circuit board 208c.

While the sensor units 102, 1002 have been described as coupling to the wheel hub 104 via the dust cap 204a in two specific manners, the sensor units 102 may be configured to couple to the wheel hub 104 in different manners, which may include press-fit inserts (e.g., directly sealing the opening 204b of the dust cap 204a without a separable seal), adhesives (e.g., a suitable tape or liquid adhesive surround the opening 204b and forming a seal with the sensor unit 102), magnetic interfaces or couplings, threaded couplings, seals of varying sizes to accommodate different dust caps, or clamp rings).

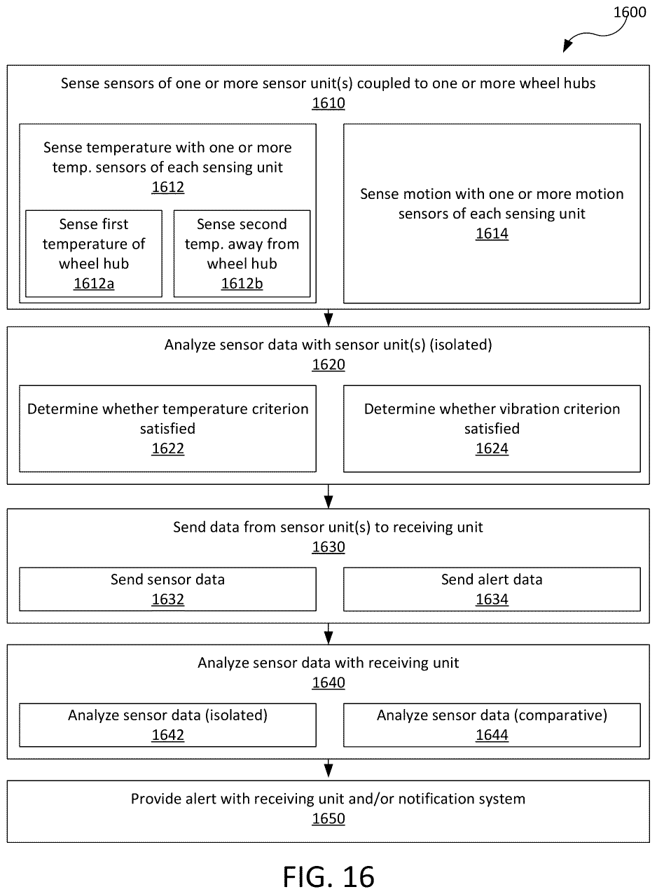

Referring to FIG. 16, a method 1600 is provided for monitoring conditions of one or more wheel hubs with one or more of the sensor units 102. The method 1600 generally includes sensing 1610, analyzing 1620 sensor data with a sensor unit 102, sending 1630 data to a receiving device 108, analyzing 1640 data with the receiving device 108, and/or providing 1650 alerts.

The sensing 1610 includes sensing 1612 temperature and may further include sensing 1614 motion with the sensor unit 102 for each of the wheel hubs to which the sensor unit is coupled. The sensing 1612 temperature is performed by each of the sensor units and includes sensing 1612a a first temperature of a wheel hub (e.g., sensing the first temperature proximate the wheel hub, such as in a continuous volume with the wheel hub). The sensing of the first temperature may be performed with a first temperature sensor 112 (e.g., the thermistor 112a). The sensing 1612 may further include sensing 1612b a second temperature further from the wheel hub (e.g., in a volume that is fluidically separated from a volume containing the wheel hub or exposed to the environment). The sensing 1612b of the second temperature may be performed with a second temperature sensor 112. In the case of the sensor unit 102 being configured to operate in a first state and a second state, or in a first, second, and third state, the sensing 1612 temperature is not performed in the first state.

The sensing 1614 motion is performed with one or more of the motion sensors 114, which may include sensing acceleration and/or include sensing velocity (e.g., rotational velocity). In the case of the sensor unit 102 being configured to operate in a first and second state, or in a first, second, and third state, the sensing 1614 motion is performed in the first state and may be performed in the second and/or third states.

Method may include analyzing 1620 sensor data with the sensor units 102 without the analyzing 1640, include the analyzing 1640 sensor data with the receiving unit without the analyzing 1620, or include both the analyzing 1620 and the analyzing 1640.

The analyzing 1620 sensor data may be performed with the controller 117 and includes analyzing 1622 whether one or more temperature criteria are satisfied and may further include analyzing 1624 whether one or more motion (e.g., vibration or rotation) criteria are satisfied, which may indicate an anomalous condition of the wheel hub.

The analyzing 1622 temperature criteria includes comparing the temperature sensed in the sensing 1612 to one or more temperature criteria. For example, the analyzing 1622 may include determining whether the sensed temperature satisfies one or more of the threshold temperature criterion, the real-time temperature differential criterion, the baseline temperature differential criterion, or the temperature rate criterion (all described previously).

The analyzing 1624 movement criteria includes comparing the motion sensed in the sensing 1614 to one or more motion criteria. For example, the analyzing 1624 may include determining whether the motion sensed satisfies one or more of the sustained vibration criterion, the pulse vibration criterion, the frequency differential or vibration signature criterion, the stopped wheel criterion, or the motion rate change criterion (all described previously).

The sending 1630 data to the receiving device 108 is performed with the communication module 106 of each of the sensor units 102. The sending 1630 data may include sending 1632 sensor data to be used in the analyzing 1640 sensor data with the receiving device 108. The sending 1630 data may also include sending 1634 data alerts to the receiving device 108 indicative of any temperature or motion (e.g., vibration or rotation) criterion determined to be satisfied by the analyzing 1620 sensor data. In the case of the sensor units 102 operating in first, second, and third states, the sensor unit 102 may be operated in the third state if the analyzing 1620 sensor data determines one or more criteria are satisfied, which may include sending data from the sensor unit 102 to the receiving device 108 at an increased rate relative to the second state.

The analyzing 1640 sensor data is performed with the controller 108a of the receiving device 108. If the analyzing 1620 sensor data with the sensor unit 102 is not performed by the sensor unit 102, the analyzing 1640 sensor data with the receiving device 108 may include analyzing 1642 sensor data in an isolated manner, as described for the analyzing 1620 sensor data with the sensor unit 102 (i.e., in an isolated manner for each of the sensor units 102).

The analyzing 1642 sensor data may include analyzing one or more of the temperature criterion the threshold temperature criterion, the real-time temperature differential criterion, the baseline temperature differential criterion, or the temperature rate criterion (all described previously) and/or analyzing the motion criterion (e.g., the sustained vibration criterion, the pulse vibration criterion, the frequency differential or vibration signature, criterion, or the stopped wheel criterion).

Whether or not the analyzing 1620 sensor data with the sensor unit 102 is performed by the sensor unit 102, the analyzing 1640 sensor data with the receiving device 108 may include analyzing 1644 sensor data in a relativistic manner by comparing the sensor data from one of the sensor units 102 to the sensor data from one or more of the other sensor units 102 (e.g., hubs 104 on the same axle or all hubs 104 on all axles) to determine if one or more relativistic differential temperature or motion (e.g., vibration or rotation) criterion are satisfied (e.g., the relativistic temperature criterion, the relativistic vibration criterion, or the relativistic rotation criterion or rotational periodicity criterion (all described previously).

The providing 1650 alerts is performed with the receiving device 108, which may include providing the alert with the user interface 108d and/or sending an alert signal to the notification system 110 to then provide the alert. The providing 1650 alerts is performed if one of the temperature or motion (e.g., vibration or rotation) criterion is satisfied. The alert so provided may also indicates the criterion satisfied (e.g., the anomaly).

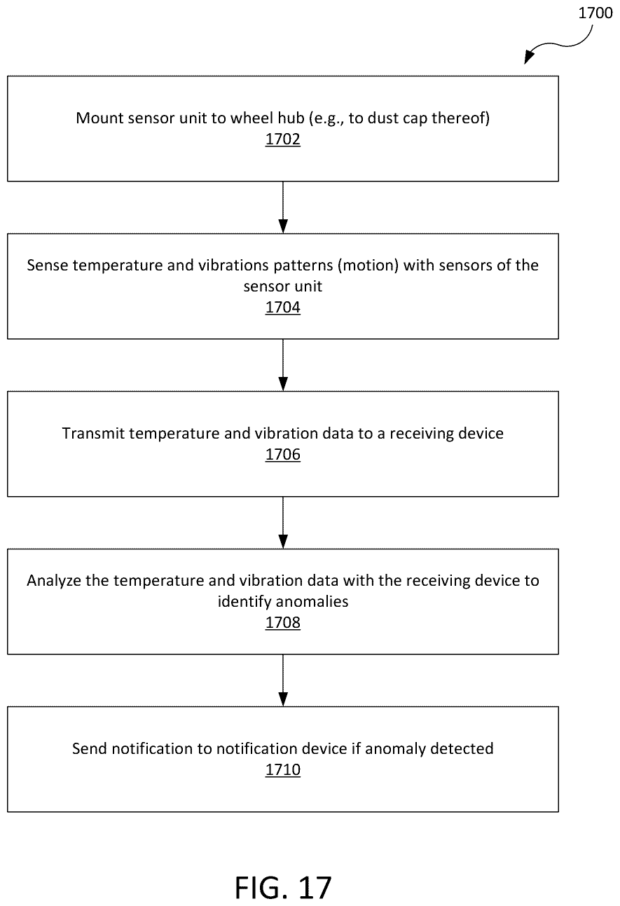

Referring to FIG. 17, a method 1700 of monitoring the condition of a wheel hub utilizing a wireless communication module 106 is illustrated. In a first step 1702, the sensor unit 102, 1002 of the monitoring system 100 is mounted to at least one wheel hub 104 of a vehicle. In examples, the sensor unit 102, 1002 may be mounted to a wheel hub 104 at the dust cap 204a as described above and illustrated in FIGS. 2A-9 and FIGS. 10-15. A sensor unit 102, 1002 may be attached to each wheel hub 104 of a towable vehicle to provide data points from more than one wheel hub 104 to provide more accurate notifications of potential failure across all wheel hubs of the vehicle.

In a second step 1704, the sensor unit 102, 1002 senses temperature and vibration patterns of the wheel hubs 104. In examples, the sensor unit 102, 1002 utilizes at least one temperature sensor 112 and at least one motion sensor 114 to detect the temperature and vibrations of the wheel hub 104 in real time.

In a third step 1706, the wireless communication module 106 wirelessly transmits the temperature data and motion data to a receiving device 108.

In a fourth step 1708, the receiving device 108 analyzes the real-time temperature and motion data to identify when the data is exceeding vibration criteria or where other anomalies in the data exists. In examples, the receiving device 108 may compare the real-time data of each individual wheel hub against an average of the data from all of the wheel hubs. If an individual wheel is experiencing temperature levels or vibration patterns outside of the criteria, the individual wheel may be experience potential failure or another safety issue. The receiving device 108 may also compare the real-time data of each individual wheel hub against historical data to determine if any of the wheel hubs are experiencing anomalies in their temperature or vibration patterns. The receiving device 108 may also receive additional information from vehicle systems 118 to incorporate into analyzing the temperature and motion data, such as tire pressure, and mileage.

In a fifth step 1710, the receiving device sends a notification to a notification system 110 such as a mobile device or a vehicle head unit to notify the vehicle operator of a potential failure or issue.

Thus, according to the disclosure, a wireless monitoring system includes a sensor unit, a receiving device, and a wireless communication module. The sensor may be provided with a temperature sensor and a motion sensor and may be configured to engage a wheel hub. The receiving device may be configured to receive data from the sensor unit. The wireless communication module may be electronically connected to the sensor unit and configured to transmit data from the sensor unit to the receiving device.

In an implementation, a method of monitoring the condition of a wheel hub using a wireless monitoring system may include mounting a sensor unit to at least one wheel hub, sensing temperature and vibration patterns of the at least one wheel hub via the sensor unit, wirelessly transmitting the temperature and vibration patterns to a receiving device, and analyzing the temperature and vibration patterns to identify data exceeding criteria.

In an implementation, a non-transitory computer-readable medium tangibly embodying computer-executable operation of a program being executable by a hardware processor may include operations including sensing a temperature and a vibration pattern of at least one wheel hub via a sensor unit engaged with wheel hub, transmitting the temperature and vibration patterns to a receiving device, comparing the temperature and vibration patterns of the at least one wheel hub, and providing a feedback to a user in real-time based on the comparison of the temperature and vibration patterns.

In an implementation, a system for monitoring wheel hubs may include a sensor unit, a wireless communication modules, and a receiving device. The sensor unit may be configured to mount to each wheel hub of a trailer and collect temperature data and vibration pattern data of each wheel hubs. The wireless communication unit may be configured to transfer the temperature data and vibration pattern data of each of the wheel hubs. The receiving device may be configured to receive and compare the temperature data and vibration pattern data of each of the wheel hubs to identify data exceeding criteria and provide a notification to an operator.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” and derivatives thereof may relate to the orientation shown in FIG. 2A. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

In the claims numerical or other indicators may be used to differentiate between multiple elements of a same name. For example, two sensor units may be referred to a first sensor unit and a second sensor unit. As another example, two criteria may be referred to as a criterion and another criterion.

In addition to the embodiments recited in the claims, disclosed herein are various embodiments that include:

Embodiment 1. A wireless monitoring system, comprising:
a sensor unit configured to couple to a wheel hub of a trailer, the sensor unit provided with a temperature sensor and a motion sensor configured to detect temperature and vibrations of the wheel hub and send data according thereto;
a receiving device configured to receive the data from the sensor unit; and
a wireless communication module electronically connected to the sensor unit and configured to transmit the data from the sensor unit to the receiving device.

Embodiment 2. The wireless monitoring system of embodiment 1, wherein the receiving device is electronically connected to at least one of a vehicle head unit and a mobile device.

Embodiment 3. The wireless monitoring system of embodiment 1, further comprising one or more additional sensor units configured to be coupled to one or more additional wheel hubs of the trailer, and
wherein the receiving device is configured to compare the data received from the sensor unit to the data received from the one or more additional sensor units.

Embodiment 4. The wireless monitoring system of embodiment 1, wherein the receiving device is configured to analyze the data for changes in the temperature during operation and detect differentials exceeding criteria.

Embodiment 5. The wireless monitoring system of embodiment 4, wherein the criteria include a temperature criteria that is one of a temperature threshold or temperature differential and include vibration criteria that includes a magnitude and duration.

Embodiment 6. The wireless monitoring system of embodiment 1, wherein the receiving device is configured to analyze patterns in the vibration levels and detect abnormalities in the patterns.

Embodiment 7. The wireless monitoring system of embodiment 1, wherein the sensor unit includes a seal for accommodating varying sizes of wheel hubs.

Embodiment 8. The wireless monitoring system of embodiment 1, wherein the receiving device is configured to electronically connect to a vehicle tire pressure monitoring system of a vehicle pulling the trailer.

Embodiment 9. The wireless monitoring system of embodiment 1, wherein the temperature sensor comprises a thermistor to assess heat dissipation from the wheel hub.

Embodiment 10. A method of monitoring a condition of a wheel hub using a wireless monitoring system, comprising:
mounting a sensor unit to at least one wheel hub;
sensing temperature and vibrations of the at least one wheel hub via the sensor unit;
wirelessly transmitting temperature data and vibration data to a receiving device according to the sensing; and
comparing the temperature data and the vibration data to criteria.

Embodiment 11. The method of embodiment 10, further comprising:
generating a notification to at least one of a mobile device or a vehicle head unit when the temperature data, the vibration data, or both exceed the criteria.

Embodiment 12. The method of embodiment 10, wherein analyzing the temperature data and the vibration data further comprises comparing the temperature data and the vibration data of more than one wheel hub.

Embodiment 13. The method of embodiment 10, wherein analyzing the temperature data and the vibration data further comprises comparing the temperature data and the vibration data to historical data of the wheel hub.

Embodiment 14. The method of embodiment 10, wherein the criteria include a temperature criteria that is one of a temperature threshold or temperature differential and includes vibration criteria that includes a magnitude and duration.

Embodiment 15. A non-transitory computer-readable medium tangibly embodying computer-executable operation of a program being executable by a hardware processor, the operations comprising:
sensing a temperature and a vibration of at least one wheel hub via a sensor unit engaged with wheel hub;
transmitting the temperature data and vibration data to a receiving device according to the sensing;
analyzing the temperature data and the vibration data of the at least one wheel hub; and
providing a feedback to a user in real-time based on the analyzing of the temperature data and the vibration data.

Embodiment 16. A system for monitoring wheel hubs of a trailer, comprising:
one or more sensors unit configured to couple to each of one or more wheel hubs of a trailer and provided to collect temperature data and vibration data of each of the wheel hubs coupled thereto;
a wireless communication unit configured to transfer the temperature data and the vibration data of each of the wheel hubs; and
a receiving device configured to receive and compare the temperature data and the vibration data of each of the wheel hubs to criteria and provide a notification to an operator.

Embodiment 17. The system of embodiment 16, further comprising a notification system including at least one of a mobile device or vehicle head unit.

Embodiment 18. The system of embodiment 16, wherein the receiving device is configured to compare the temperature data and vibration data in real-time to historical temperature data and vibration data.

Embodiment 19. The system of embodiment 16, further comprising a wireless repeater for extending a range of the wireless communication unit.

Embodiment 20. The system of embodiment 16, wherein the sensor unit further comprises a thermal conductivity sensor configured to assess the efficiency of heat dissipation from the wheel hub.

Embodiment 21. A wireless monitoring system, comprising:
a sensor unit having a housing and a temperature sensor located in the housing and configured to detect temperature of a wheel hub;
wherein the housing includes a first portion configured to couple to a dust cap of the wheel hub and a second portion configured to couple to a dust seal that is otherwise configured to couple to the dust cap.

What is claimed is:

1. A monitoring system configured to monitor one or more wheel hubs of a trailer or vehicle, the monitoring system comprising:
a sensor unit having one or more temperature sensors, the sensor unit being configured to couple to a wheel hub and at least one of the temperature sensors configured to sense a temperature output by the wheel hub; and
a controller that receives temperature data from the one or more temperature sensors and analyzes the temperature data by determining whether the temperature data satisfies a temperature criterion;
wherein the controller is configured to provide an alert if the temperature data satisfies the temperature criterion.

2. The monitoring system according to claim 1, wherein the temperature criterion is one of a threshold temperature criterion or a differential temperature criterion;
wherein the sensor unit further includes one or more motion sensors, and the controller receives motion data from the one or more motion sensors and analyzes the motion data by determining whether the motion data satisfies a motion criterion, the motion criterion being one of a vibration criterion or a rotation criterion;
wherein the controller is configured to provide another alert if the motion data satisfies the motion criterion;
wherein the sensor unit includes an enclosure and the controller, and the enclosure contains the controller and the motion sensor; and
wherein the sensor unit is configured to couple to the wheel hub by the enclosure coupling to a dust cap of the wheel hub.

3. The monitoring system according to claim 1, wherein the temperature criterion is a threshold temperature criterion, and the controller determines whether a sensed temperature of the temperature data exceed the threshold temperature criterion.

4. The monitoring system according to claim 3, wherein the temperature criterion is a differential temperature criterion, and the controller determines whether a difference between a sensed temperature of the temperature data and another temperature exceeds the differential temperature criterion.

5. The monitoring system according to claim 4, wherein the differential temperature criterion is a baseline differential temperature criterion, and the controller determines whether a difference between the sensed temperature of the temperature data and a baseline temperature exceeds the baseline differential temperature criterion, the baseline temperature being a temperature characteristic determined from sensing the temperature output by the wheel hub with the temperature sensors at a previous time.

6. The monitoring system according to claim 4, wherein the sensor unit includes two of the temperature sensors, and the controller receives other temperature data from another of the temperature sensors;
wherein the differential temperature criterion is a real-time temperature differential criterion, and the controller determines whether a difference between the sensed temperature of the temperature data and another sensed temperature of the other temperature data exceeds the real-time temperature differential criterion, the sensed temperature and the other sensed temperature being sensed contemporaneously.

7. The monitoring system according to claim 1, wherein the sensor unit further includes one or more motion sensors, and the controller receives motion data from the one or more motion sensors and analyzes the motion data by determining whether the motion data satisfies a motion criterion.

8. The monitoring system according to claim 7, wherein the motion criterion is one of a vibration criterion or a rotation criterion.

9. The monitoring system according to claim 7, further comprising another of the sensor units, the other sensor unit being configured to couple to another wheel hub of a same trailer having the wheel hub; and
a receiving device configured to receive the temperature data and the motion data from the sensor unit and other temperature data and other motion data from the other sensor unit.

10. The monitoring system according to claim 1, wherein the sensor unit includes an enclosure and the controller, and the enclosure contains the controller;
wherein the sensor unit is configured to couple to the wheel hub by the enclosure coupling to a dust cap of the wheel hub.

11. A monitoring system configured to monitor multiple wheel hubs of a trailer or vehicle, the monitoring system comprising:
a first sensor unit configured to couple to a first wheel hub of a trailer, the first sensor unit having a first sensor that senses a first characteristic of the first wheel hub and a first controller that receives first data from the first sensor, the first characteristic being one of temperature or motion;
a second sensor unit configured to couple to a second wheel hub of the trailer, the second sensor unit having a second sensor that senses a second characteristic of the second wheel hub and a second controller that receives second data from the second sensor, the second characteristic being the first characteristic; and
a receiving device having a third controller that receives the first data from the first controller of the first sensor unit and the second data from the second controller of the second unit, wherein the third controller analyzes the first data and the second data by determining whether a difference between the first data and the second data satisfies a differential criterion;
wherein the receiving device provides an alert if the differential criterion is satisfied.

12. The monitoring system according to claim 11, wherein the first characteristic and the second characteristic are motion;
wherein the differential criterion is a rotational velocity criterion, and the third controller determines whether a difference between a first rotational velocity of the first data and a second rotational velocity of the second data exceeds the rotational velocity criterion;
wherein the first controller analyzes the first data by determining whether the first data satisfies another criterion irrespective of the second data, and the first controller provides a first alert if the first data satisfies the other criterion; and
wherein the second controller analyzes the second data by determining whether the second data satisfies the other criterion irrespective of the first data, and the second controller provides a second alert if the second data satisfies the other criterion.

13. The monitoring system according to claim 11, wherein the first characteristic and the second characteristic are motion; and
wherein the differential criterion is a rotational velocity criterion, and the third controller determines whether a difference between a first rotational velocity of the first data and a second rotational velocity of the second data exceeds the rotational velocity criterion.

14. The monitoring system according to claim 11, wherein the first controller analyzes the first data by determining whether the first data satisfies another criterion irrespective of the second data, and the first controller provides a first alert if the first data satisfies the other criterion; and
wherein the second controller analyzes the second data by determining whether the second data satisfies the other criterion irrespective of the first data, and the second controller provides a second alert if the second data satisfies the other criterion.

15. The monitoring system according to claim 14, wherein the first characteristic and the second characteristic are motion and the other criterion is a motion criterion;
wherein the first sensor unit includes a third sensor that senses temperature of the first wheel hub, and the second unit includes a fourth sensor that senses temperature of the second wheel hub;
wherein the first controller analyzes the third data by determining whether the third data satisfies a temperature criterion irrespective of the fourth data and outputs a third alert if the third data satisfies the temperature criterion; and
wherein the second controller analyzes the fourth data by determining whether the fourth data satisfies the temperature criterion irrespective of the third data, and outputs a fourth alert if the fourth data satisfies the temperature criterion.

16. The monitoring system according to claim 11, wherein the first sensor unit includes a first enclosure that contains the first controller and the first sensor, the first enclosure being configured to couple to a first dust cap of the first wheel hub; and
wherein the second sensor unit includes a second enclosure that contains the second controller and the second sensor, the second enclosure being configured to couple to a second dust cap of the second wheel hub.

17. A monitoring system configured to monitor one or more wheel hubs of a trailer or vehicle, the monitoring system comprising:
a sensor unit having an enclosure that contains or is coupled to a sensor and contains a power source, a controller, and a wireless communication module;
wherein the enclosure is configured to couple to a dust cap of a wheel hub; and
wherein the sensor is configured to detect a characteristic of the wheel hub, and the controller receives data from the sensor and is configured to at least one of analyze the data or wirelessly transmit the data with the communication module.

18. The monitoring system according to claim 17, further comprising a seal that is configured to couple to an opening of the dust cap of the wheel hub, and the enclosure is configured to couple to the seal to close the opening of the dust cap and couple the sensor unit to the wheel hub.

19. The monitoring system according to claim 18, wherein the sensor is a temperature sensor that is positioned to sense temperature of the wheel hub inside the other dust cap.

20. The monitoring system according to claim 19, further comprising another sensor unit, another seal, and a receiving device;
wherein the other sensor unit includes another enclosure that contains or is coupled to another sensor and contains another power source, another controller, and another wireless communication module;
wherein the other enclosure is configured to couple to another dust cap of another wheel hub;
wherein the other sensor is a temperature sensor that is positioned to sense temperature of the other wheel hub from inside the other dust cap, and the controller receives other data from the other sensor and is configured to at least one of analyze the other data or wirelessly transmit the other data with the other communication module to the receiving device; and
the controller is configured to transmit the data with the communication module to the receiving device.
